(19) United States
(12) Patent Application Publication
(10) Pub. No.: US 2007/0063681 A1
(43) Pub. Date: Mar. 22, 2007

(54) Direct mode pulse width modulation for DC to DC converters

(75) Inventor: Kwang-Hwa Liu, Sunnyvale, CA (US)

Correspondence Address: BIRCH STEWART KOLASCH & BIRCH, PO BOX 747, FALLS CHURCH, VA, 22040-0747, US

(73) Assignee: AMAZION ELECTRONICS, INC.

(21) Appl. No.: 11/227,130

(22) Filed: Sep. 16, 2005

(51) Int. Cl. G05F 1/00

(52) U.S. Cl. 323/282

(57) ABSTRACT

A DC to DC converter has an inverter, an inductor, a voltage sensor, a comparator, a clock generator, a driver and an output capacitor. The inverter converts an input voltage into a square-wave voltage. The inductor is electrically connected to an output of the inverter. The voltage sensor is electrically connected to the inductor and derives a sense voltage. The comparator compares the sense voltage and a reference voltage. The clock generator generates a reference clock pulse. The driver is triggered by the reference clock pulse and switches the inverter according to an output of the comparator. The output capacitor is electrically connected between the voltage sensor and the ground.

### BACKGROUND

1. Field of Invention

The present invention relates to the DC to DC converters. More particularly, the present invention relates to pulse width modulation (PWM) DC to DC converters.

2. Description of Related Art

DC to DC converters are well known in the field of electronics. Such circuitry or devices are typically employed to convert from one DC voltage level to another DC voltage level. They are used in a variety of environments. For instance, several kinds of such converters are used to supply microprocessor core voltage. One kind of such converters is referred to as a fixed frequency converter, also known as a pulse-width modulated (PWM) converter. PWM converters include voltage mode converters and current mode converters.

FIG. 1A is a circuit diagram of a voltage mode PWM converter; and FIG. 1B is a graph illustrating PWM timing and waveforms of the converter illustrated in FIG. 1A. The following description is made with reference to FIGS. 1A and 1B. A voltage mode PWM converter 100 includes a control loop that contains an error amplifier 102, a comparator 104 and an SR flip-flop 106. The output voltage (Vout) is compared with a reference voltage (Vref) at the inputs of the error amplifier 102. The comparator 104 receives the output (Vea) of error amplifier 102 as its first input and receives a saw-tooth or a triangle signal (Vramp) as its second input. The comparators output is a PWM signal that is provided for SR flip-flop 106 to drive an inverter 108 containing two power switches Q1 and Q2. For simplicity of discussion, power switch Q1 is assumed as a p-channel MOSFET, and power switch Q2 is assumed as an n-channel MOSFET.

As illustrated in FIG. 1B, if the output current (lout) is increased, the voltage (V_{Cout}) of an output capacitor (Cout) 112 begins to decrease to stably maintain the inductor current (IL) for a while; thus the additional load current is provided by the output capacitor 112. The decreased V_{Cout} causes the Vout 114 to decrease as well, and consequently Vea increases since Vout 114 is connected to the inverse input of error amplifier 102.

SR flip-lop 106 is triggered by a clock with a fixed frequency (e.g. 500 kHz). SR flop-flop 106 is reset when Vramp (rising from 0V to 5V) exceeds the level of Vea. The tuned-on time (Ton) of the power switch Q1 is from T0 (at the beginning of a new clock pulse) to T1 (when Vramp exceeds Vea). The turned-on time of the power switch Q2 is from T1 to T2 (at the beginning of another new clock pulse). When power switch Q1 is turned on, the inductor current (IL) increases with a slope of (Vin-Vout)/L. After power switch Q1 is turned off, power switch Q2 is turned on, and the inductor current (IL) decreases with a slope of (−Vout)/L.

The voltage mode PWM converter 100 generally requires a complicated feedback compensation design due to the double poles present in its output filter (comprising the inductor L and the output capacitor 112). However, no inductor current or load current information is found in the foregoing control loop. Any change of the load current can only be indicated by a change of the output voltage Vout when a higher or lower load current discharges the output capacitor 112 at a different rate. Major disadvantage of voltage mode is its slow response to load transients, owing to the compensation needed on error amplifier 102 to stabilize the control loop. And due to the lack of inductor current information, the voltage mode PWM converter 100 is not suitable for parallel operation. For example, two voltage mode PWM converters operating in parallel may have exactly the same duty cycles, yet one converter may carry a much larger portion of load current than the other converter.

FIG. 2A is a circuit diagram of a current mode PWM converter, and FIG. 2B is a graph illustrating PWM timing and waveforms of the converter illustrated in FIG. 2A. The following descriptions are made with reference to FIGS. 2A and 2B. A current mode PWM converter 200 includes two control loops: an inner current loop and an outer voltage loop which controls the inner current loop. The inner current loop consists of a current sensor 214, a comparator 204 that uses as inputs the error voltage from the outer voltage loop and the output of current sensor 214, an SR driver 206 that is set every time by the clock and reset by the output of comparator 204, and an inverter 208. The outer voltage loop includes an error amplifier 202 which compares the output voltage (Vout) with a reference voltage (Vref). The output (Vea) of error amplifier 202 is the reference for the inner current loop.

However, a good current sense scheme is necessary for the current mode PWM converter 200, such as that achieved by a current-sense resistor or by sensing the on-state drain-source voltage of the power switch (commonly known as Rds current sensing). A discrete sensing resistor is expensive and introduces additional conduction loss. A high-side Rds sensing (on power switch Q1) suffers from short duty cycle and heavy switching noise, whereas a low-side Rds sensing (on power switch Q2) is out of phase with the turned-on time (Ton) of power switch Q1. The low-side Rds sensing thus generally requires a sample and hold circuit to be useful.

In many cases, because of the device parameter spread (such as Rds) and the current-sense amplifier input offset voltage, the extraction of inductor current information is significantly inaccurate. The current mode PWM converter 200 still requires an error amplifier 202 to derive an error voltage. Moreover, its compensation network, although simpler than that of the voltage mode PWM converter 100, still demands careful and elaborate design. In addition, for a multi-phase (parallel operation) design, each converter needs a separate current sensor, causing proportionally higher implementation cost.

FIG. 3A is a circuit diagram of a ripple mode converter, and FIG. 3B is a graph illustrating timing and waveforms of the converter illustrated in FIG. 3A. The following descriptions are made with reference to FIGS. 3A and 3B. The ripple mode converter 300 requires only two comparators 304 and 314 without the need for any error-amplifier or associated compensation network.

As illustrated in FIG. 3B, when the sense voltage (Vsen), i.e. the output voltage (Vout), is lower than a lower reference voltage (VRL) at TO, power switch Q1 is turned on, and the inductor current (IL) and the output voltage (Vout) consequently increase. Power switch Q1 remains turned on until at T1 the output voltage (Vout) reaches the upper bound, a higher reference voltage (VRH), and then power switch Q1 is turned off whereas power switch Q2 is turned on. The inductor current (IL) decreases and so does the output voltage (Vout). Power switch Q2 remains turned on until at T2 the output voltage (Vout) drops to the lower bound (VRL). Subsequently, power switch Q1 is turned on and power switch Q2 is turned off.

The ripple mode converter is inherently stable since it basically incorporates a bang-bang control scheme. Whenever the output voltage (Vout) falls outside of the regulation band, an instant correction quickly brings the output voltage (Vout) back into regulation. Moreover, the ripple mode converter has fast transient response, in which any error of the output voltage is corrected immediately within one stroke.

However, the switching frequency of the ripple mode converter is not constant. Moreover, if its output capacitor has a low ESR, the ripple of the output voltage (Vout) is very small, it will lead to jittery switching frequency. Further no inductor current (IL) information, neither the load current information, is contained in the regulation loop of the ripple mode converter. Therefore, when two converters are operated in parallel, one converter may carry a much larger portion of load current than the other converter. Consequently, ripple mode converters are generally considered as not suitable for multi-phase applications difficult.

### SUMMARY

It is therefore an aspect of the present invention to provide a DC to DC converter, which has a simple control circuit, is inherently stable, and is of fast transient response.

According to one preferred embodiment of the present invention, the DC to DC converter comprises an inverter, an inductor, a voltage sensor, a comparator, a clock generator, a driver, and an output capacitor. The inverter converts an input voltage into a square-wave voltage. The inductor is electrically connected to the output of the inverter. The voltage sensor is electrically connected to the inductor and derives a sense voltage. The comparator compares the sense voltage and a reference voltage. The clock generator generates a reference clock pulse train of constant frequency. The driver is triggered by the reference clock pulse and switches the inverter according to the output of the comparator.

According to another preferred embodiment of the present invention, the DC to DC converter comprises an inverter, an inductor, a sense resistor, an output capacitor, a comparator, and a driver. The inverter receives an input voltage and outputs a square-wave voltage. A first end of the inductor is electrically connected to an output of the inverter, A first end of the sense resistor is electrically connected to a second end of the inductor. A second end of the sense resistor is electrically connected to an output capacitor. The comparator compares a voltage positioned between the inductor and the sense resistor. The driver is triggered by a reference clock pulse and switches the inverter according to an output of the comparator.

According to another preferred embodiment of the present invention, the DC to DC converter comprises an inverter, an inductor, a sense resistor, a sense capacitor, a comparator and a driver. The inverter receives an input voltage and outputs a square-wave voltage. A first end of the inductor is electrically connected to an output of the inverter. A first end of the sense resistor is electrically connected to the first end of the inductor. A first end of the sense capacitor is electrically connected to a second end of the inductor, and a second end of the sense capacitor is electrically connected to a second end of the sense resistor. The comparator compares a voltage positioned between the sense capacitor and the sense resistor. The driver is triggered by a reference clock pulse and switches the inverter according to an output of the comparator.

It is to be understood that both the foregoing general description and the following detailed description are examples and are intended to provide further explanation of the invention as claimed.

### BRIEF DESCRIPTION OF THE DRAWINGS

These and other features, aspects and advantages of the present invention will become better understood with regard to the following description, appended claims and accompanying drawings where:

FIG. 1A is a circuit diagram of a voltage mode PWM converter;

FIG. 1B is a graph illustrating PWM timing and waveforms of the converter illustrated in FIG. 1A;

FIG. 2A is a circuit diagram of a current mode PWM converter;

FIG. 2B is a graph illustrating PWM timing and waveforms of the converter illustrated in FIG. 2A;

FIG. 3A is a circuit diagram of a ripple mode converter;

FIG. 3B is a graph illustrating timing and waveforms of the converter illustrated in FIG. 3A;

FIG. 4A is a circuit diagram of one preferred embodiment of the present invention;

FIG. 4B is a graph illustrating PWM timing and waveforms of the converter illustrated in FIG. 4A;

FIG. 5A is a circuit diagram of another preferred embodiment of the present invention;

FIG. 5B is a circuit diagram of another preferred embodiment of the present invention;

FIG. 6A is a circuit diagram of another preferred embodiment of the present invention, and

FIG. 6B is a graph illustrating PWM timing and waveforms of the converter illustrated in FIG. 6A.

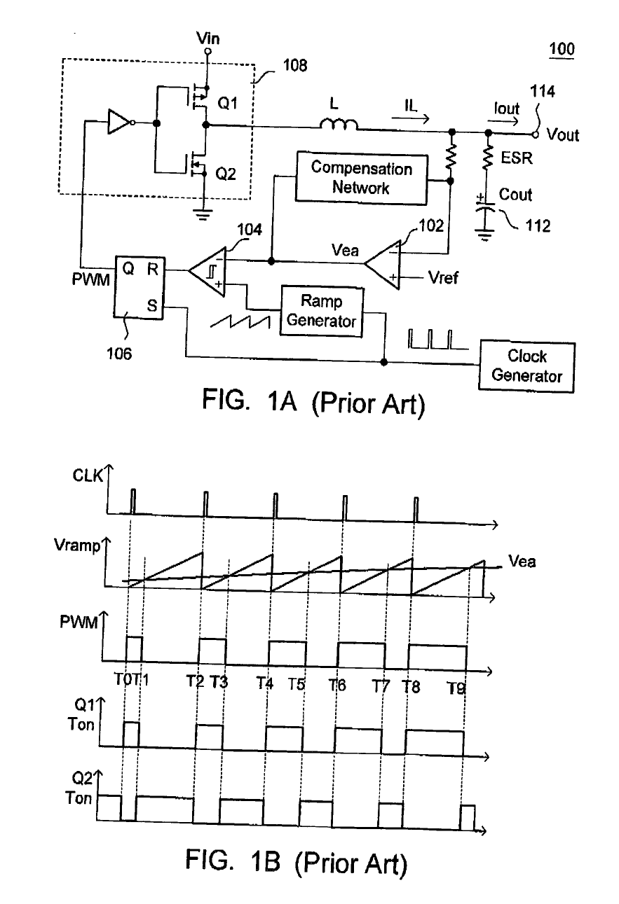

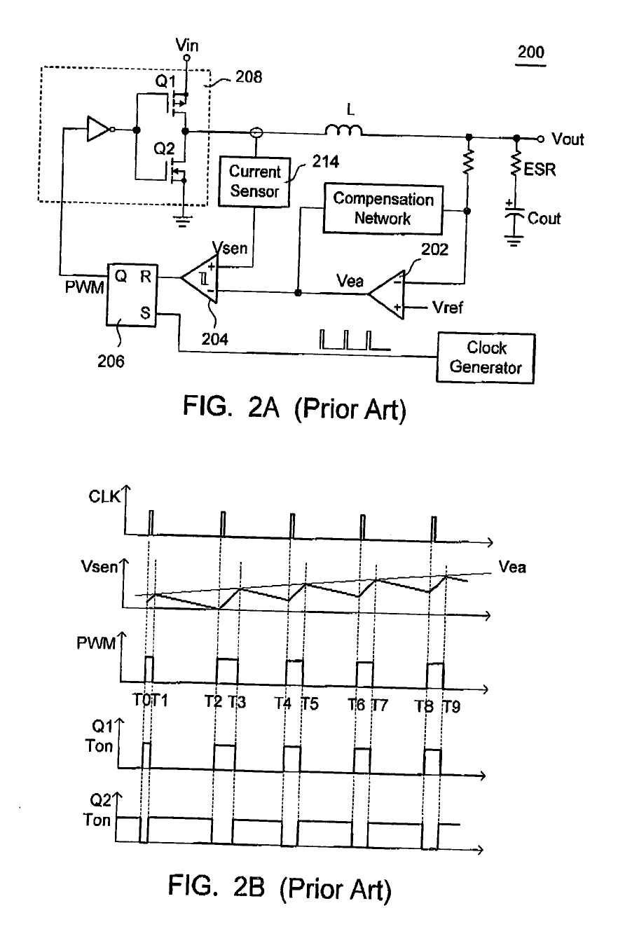

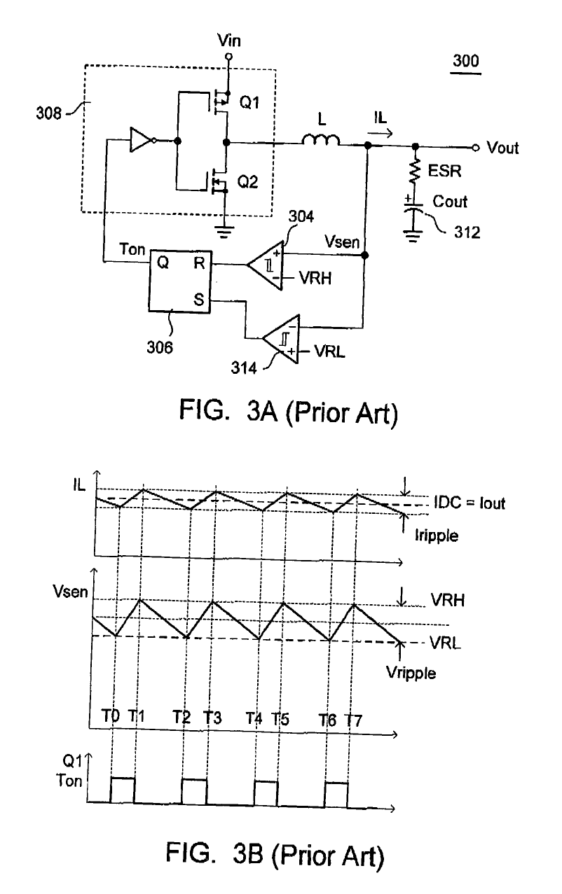

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The present invention feeds back the output voltage (Vout) by a voltage sensor, which contains the information of the output voltage (Vout) as well as the inductor DC current. The DC to DC converter of the present invention has a constant switching frequency and supports a low ESR output capacitor. The control circuit of the DC to DC converter is simple, inherently stable, and has fast transient response. Furthermore, the DC to DC converter has inherent current-sharing characteristics, ideal for multi-phase applications, such as several converters operating in parallel.

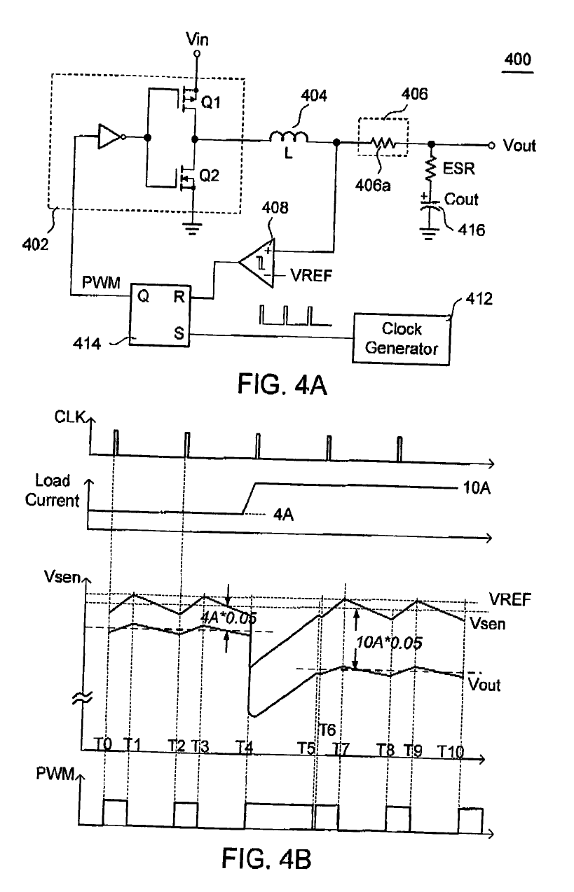

FIG. 4A is a circuit diagram of one preferred embodiment of the present invention, and FIG. 4B is a graph illustrating PWM timing and waveforms of the converter illustrated in FIG. 4A. The following descriptions are made with reference to FIGS. 4A and 4B. A direct mode DC to DC converter 400 comprises an inverter 402, an inductor 404, a voltage sensor 406, a comparator 408, a clock generator 412, a driver 414 and an output capacitor 416.

The inverter 402 converts an input voltage (Vin) into a square-wave voltage. The inductor 404 is electrically connected to the output of inverter 402. Voltage sensor 406 is electrically connected to inductor 404 and derives a sense voltage (Vsen). Comparator 408 compares the sense voltage (Vsen) and a reference voltage (VREF). Clock generator 412 generates a reference clock pulse. Driver 414 is triggered by the reference clock pulse and switches inverter 402 according to the output of comparator 408.

More precisely, inverter 402 receives the input voltage and then outputs a square-wave voltage. Voltage sensor 406 of the preferred embodiment contains a sense resistor 406a. The first end of inductor 404 is electrically connected to the output of inverter 402, The first end of sense resistor 406a is electrically connected to the second end of inductor 404. Therefore, the sense voltage (Vsen) is derived between sense resistor 406a and inductor 404.

Moreover, driver 414 can be an SR latch, a flip-flop or other suitable driving circuit. The direct mode DC to DC converter 400 further comprises an output capacitor (Cout) 416, which is electrically connected between a second end of sense resistor 406a and the ground. Inverter 402 comprises two switches, such as power switches Q1 and Q2, which are electrically connected in series between the input voltage (Vin) and the ground. The two switches Q1 and Q2 are alternately switched and the output of inverter 402 is positioned between the two switches Q1 and Q2.

As illustrated in FIG. 4B, the sense resistor 406a is assumed to be 5 mΩ, and the equivalent series resistance (ESR) of the output capacitor 416 is also assumed to be 5 mΩ. When the load current is maintained at 4.0 A, direct mode DC to DC converter 400 operates in a steady state where the voltage (V_{Cout}) of output capacitor 416 is 20 mV below the reference voltage (VREF). If the load current is suddenly increased from 4.0 A to 10.0 A at about T4, the voltage (V_{Cout}) of output capacitor 416 drops instantaneously.

In the next two cycles, power switch Q1 remains fully turned on until the sense voltage (Vsen) reaches the reference voltage (VREF) at T7. After T7, the direct mode DC to DC converter 400 operates in a new steady state where the voltage (V_{Cout}) of the output capacitor 416 is 50 mV below the reference voltage (VREF). Accordingly, the direct mode DC to DC converter 400 can be naturally stable and with fast dynamic response, which recovers optimally to regulation in the event of a load step change.

In short, the feedback point of the output voltage (Vout) is connected to the inductor side of a sense resistor 406a. The voltage at this feedback point contains both the output voltage (Vout) information and the inductor DC current information. Moreover, the direct mode DC to DC converter 400 requires only one comparator 408 without the need for any error amplifier or compensation network. Therefore it achieves all of the above stated goals. The only matter needing attention is that the DC regulation error is proportional to the load current multiplied by the current-sense resistance, By a proper minimization of current-sense resistance, the load regulation error can be controlled such that it is less than 1%.

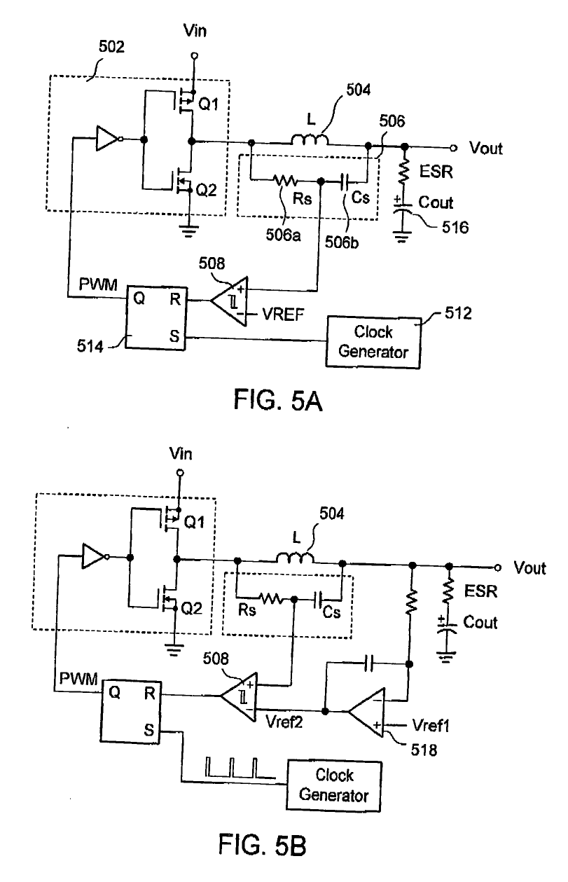

FIG. 5A is a circuit diagram of another preferred embodiment of the present invention, illustrating an alternative embodiment utilizing an inductor DCR sensing technique. A direct mode DC to DC converter 500 comprises an inverter 502, an inductor 504, a voltage sensor 506, a comparator 508, a clock generator 512, a driver 514, and an output capacitor 516. Inverter 502 converts an input voltage (Vin) into a square-wave voltage. Inductor 504 is electrically connected to the output of inverter 502. Voltage sensor 506 is electrically connected to inductor 504 and derives a sense voltage (Vsen). Comparator 508 compares the sense voltage (Vsen) and a reference voltage (VREF). Clock generator 512 generates a reference clock pulse. Driver 514 is triggered by the reference clock pulse and switches inverter 502 according to the output of comparator 508.

More precisely, inverter 502 receives the input voltage and then outputs a square-wave voltage. Voltage sensor 506 of the preferred embodiment contains a sense resistor 506a and a sense capacitor 506b. The first end of inductor 504 is electrically connected to the output of inverter 502. The first end of sense resistor 506a is electrically connected to the first end of inductor 504. The first end of sense capacitor 506b is electrically connected to the second end of inductor 504, and the second end of sense capacitor 506b is electrically connected to the second end of sense resistor 506a. The sense voltage is derived between sense capacitor 506b and sense resistor 506a.

Preferably, the resistance Rs of sense resistor 506a, the capacitance Cs of sense capacitor 506b, and the inductance L and the DC resistance DCR of inductor 504 follows an equation as:
Rs×Cs=L/DCR (1)

Equation (1) describes a loss-less inductor current sense scheme. The stray resistance of inductor 504 can be incorporated together as a single resistor, the DC resistance (DCR). By matching Rs×Cs with L/DCR, it can be shown that the voltage drop on the DCR (i.e. IL×DCR) is duplicated as the voltage across sense capacitor 506b.

Moreover, driver 514 can be an SR latch, a flip-flop or other suitable driving circuit. Direct mode DC to DC converter 500 further comprises an output capacitor 516, which is electrically connected between the first end of sense capacitor 506b and the ground. Inverter 502 comprises two switches, such as power switches Q1 and Q2, which are electrically connected in series between the input voltage (Vin) and the ground. The two switches Q1 and Q2 are alternately switched and the output of inverter 502 is positioned between the two switches Q1 and Q2.

FIG. 5B is a circuit diagram of another preferred embodiment of the present invention. As mentioned above, in the preferred embodiment illustrated by FIG. 4A, the regulation output voltage (Vout) decreases slightly when the load current increases, the amount of drop being proportional to the product of the DC current (I_{DC}) and the DC resistance of the inductor (DCR). One way to eliminate the voltage regulation error is to add a DC error correction circuit, an exemplary implementation of which is illustrated in FIG. 5B.

An error amplifier 518 is used to provide a reference voltage (Vref2) for comparator 508. The inverse input of an error amplifier 518 is electrically connected to the second end of inductor 504 and the output of error amplifier 518. The non-inverse input of error amplifier 518 is electrically connected to another reference voltage (Vref1). As long as error amplifier 518 has sufficient low-frequency gain, the output voltage (Vout) is regulated to the reference voltage (Vref1) regardless of the magnitude of the load current.

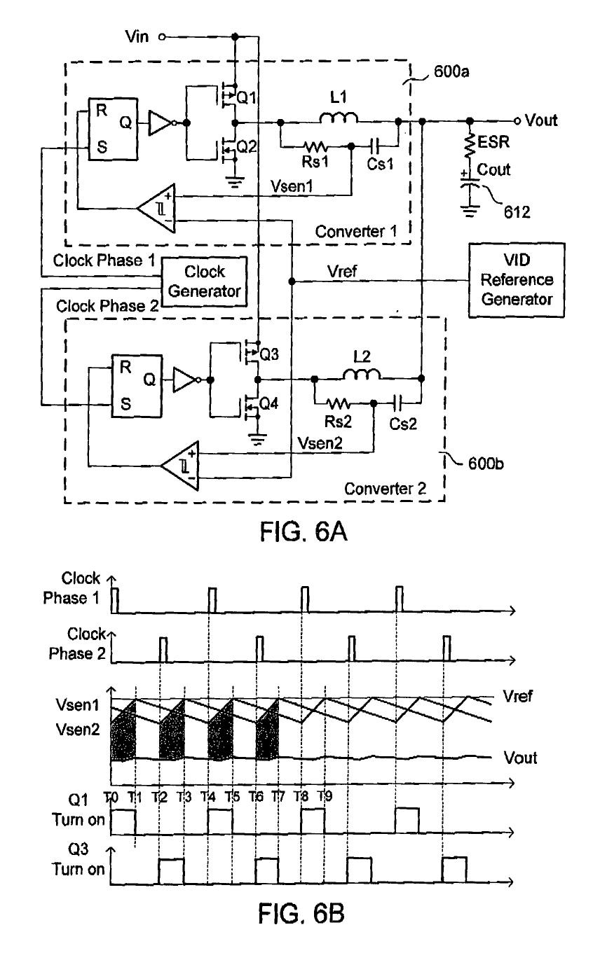

FIG. 6A is a circuit diagram of another preferred embodiment of the present invention, and FIG. 6B is a graph illustrating PWM timing and waveforms of the converter illustrated in FIG. 6A. The following descriptions are made with reference to FIGS. 6A and 6B. The preferred embodiment requires no external control to achieve good current balance. At least two direct mode PWM converters 600a and 600b can be operated in parallel with excellent natural current balancing ability. When all channels, the converters 600a and 600b, share a common reference voltage (Vref) and a common output voltage (Vout), each of them can provide the same amount of current in consideration of a difference between the reference voltage (Vref) and the output voltage (Vout). The difference can be made up by DCR*I_{DC}+0.5*I_{AC}*(ESR+DCR), where I_{AC} represents the inductor ripple current. Moreover, all converters 600a and 600b can share a common error amplifier and a common second reference voltage.

If each channel uses an inductor of the same size, its inductance L and DCR are equal to those of other channels. Furthermore, since all channels commonly share an output capacitor 612, they have the same equivalent series resistance (ESR) from the output capacitor 612. Consequently, each channel equally shares the load current. Moreover, the preferred embodiment has an automatically thermal balancing effect. For example, if one channel carries more current (due to lower DCR), then its inductor heats up more, making its DCR higher, which in turn, decreases its current

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A DC to DC converter, comprising:
an inverter, arranged to convert an input voltage into a square-wave voltage;
an inductor, electrically connected to an output of the inverter;
a voltage sensor, electrically connected to the inductor and arranged to derive a sense voltage;
a comparator, arranged to compare the sense voltage and a reference voltage;
a clock generator, arranged to generate a reference clock pulse;
a driver, triggered by the reference clock pulse and arranged to switch the inverter according to an output of the comparator; and
an output capacitor, electrically connected between the voltage sensor and the ground.

2. The DC to DC converter as claimed in claim 1, wherein when a first end of the inductor is electrically connected to the output of the inverter, the voltage sensor comprises;
a sense resistor, a first end of the sense resistor being electrically connected to a second end of the inductor, and the sense voltage being derived between the sense resistor and the inductor.

3. The DC to DC converter as claimed in claim 1, wherein when a first end of the inductor is electrically connected to the output of the inverter, the voltage sensor comprises:
a sense resistor, a first end of the sense resistor being electrically connected to the first end of the inductor;
a sense capacitor, a first end of the sense capacitor being electrically connected to a second end of the inductor, and a second end of the sense capacitor being electrically connected to a second end of the sense resistor; and
wherein the sense voltage is derived between the sense capacitor and the sense resistor.

4. The DC to DC converter as claimed in claim 3, wherein the resistance Rs of the sense resistor, the capacitance Cs of the sense capacitor, and the conductance L and the DC resistance DCR of the inductor follow an equation as:
Rs×Cs=L/DCR

5. The DC to DC converter as claimed in claim 3, further comprising an error amplifier arranged to provide the reference voltage, wherein an inverse input of the error amplifier is electrically connected to the second end of the inductor and a non-inverse input of the error amplifier is electrically connected to another reference voltage.

6. The DC to DC converter as claimed in claim 1, wherein the inverter comprises two switches electrically connected in series between the input voltage and the ground, the two switches are alternately switched and the output of the inverter is positioned between the two switches.

7. The DC to DC converter as claimed in claim 1, wherein the driver is an SR latch or a flip-flop.

8. A DC to DC converter, comprising:
an inverter arranged to receive an input voltage and output a square-wave voltage;
an inductor, a first end of the inductor being electrically connected to an output of the inverter;
a sense resistor, a first end of the sense resistor being electrically connected to a second end of the inductor;
a comparator, arranged to compare a voltage positioned between the inductor and the sense resistor
a driver, triggered by a reference clock pulse and arranged to switch the inverter according to an output of the comparator; and
an output capacitor, electrically connected between a second end of the sense resistor and the ground.

9. The DC to DC converter as claimed in claim 8, further comprising:
a clock generator, arranged to generate the reference clock pulse.

10. The DC to DC converter as claimed in claim 8, wherein the inverter comprises two switches electrically connected in series between the input voltage and the ground, the two switches are alternately switched and the output of the inverter is positioned between the two switches.

11. The DC to DC converter as claimed in claim 8, wherein the driver is an SR latch or a flip-flop.

12. A DC to DC converter, comprising:
an inverter, arranged to receive an input voltage and output a square-wave voltage;
an inductor, a first end of the inductor being electrically connected to an output of the inverter,
a sense resistor, a first end of the sense resistor being electrically connected to the first end of the inductor;
a sense capacitor, a first end of the sense capacitor being electrically connected to a second end of the inductor, and a second end of the sense capacitor being electrically connected to a second end of the sense resistor;
a comparator, arranged to compare a voltage positioned between the sense capacitor and the sense resistor
a driver, triggered by a reference clock pulse and arranged to switch the inverter according to an output of the comparator; and
an output capacitor, electrically connected between a second end of the sense resistor and the ground.

13. The DC to DC converter as claimed in claim 12, wherein the resistance Rs of the sense resistor, the capacitance Cs of the sense capacitor, and the conductance L and the DC resistance DCR of the inductor follow an equation as:
Rs×Cs=L/DCR

14. The DC to DC converter as claimed in claim 12, further comprising an error amplifier arranged to provide the reference voltage, wherein an inverse input of the error amplifier is electrically connected to the second end of the inductor, and a non-inverse input of the error amplifier is electrically connected to a second reference voltage.

15. The DC to DC converter as claimed in claim 12, further comprising:
a clock generator, arranged to generate the reference clock pulse.

16. The DC to DC converter as claimed in claim 12, wherein the inverter comprises two switches electrically connected in series between the input voltage and the ground, the two switches are alternately switched and the output of the inverter is positioned between the two switches.

17. The DC to DC converter as claimed in claim 12, wherein the driver is an SR latch or a flip-flop.

18. A set of DC to DC converters, the set comprising:
a plurality of DC to DC converters electrically coupled to be operated in parallel, wherein each of the DC to DC converters comprises:
an inverter, arranged to convert an input voltage into a square-wave voltage;
an inductor, electrically connected to an output of the inverter;
a voltage sensor, electrically connected to the inductor and arranged to derive a sense voltage;
a comparator, arranged to compare the sense voltage and a reference voltage;
a driver, triggered by a reference clock pulse and arranged to switch the inverter according to an output of the comparator; and
an output capacitor, electrically connected between the voltage sensor and the ground;
wherein the reference clock pulses of different DC to DC converters are of different clock phases.

19. The set of DC to DC converters as claimed in claim 18, further comprising a clock generator arranged to generate the reference clock pulses, and wherein the DC to DC converters share the same reference voltage.

20. The set of DC to DC converters as claimed in claim 18, wherein when a first end of the inductor is electrically connected to the output of the inverter, the voltage sensor of each of the DC to DC converters comprises:
a sense resistor, a first end of the sense resistor being electrically connected to a second end of the inductor, and the sense voltage being derived between the sense resistor and the inductor.

21. The set of DC to DC converters as claimed in claim 18, wherein when a first end of the inductor is electrically connected to the output of the inverter, the voltage sensor of each of the DC to DC converters comprises:
a sense resistor, a first end of the sense resistor being electrically connected to the first end of the inductor;
a sense capacitor, a first end of the sense capacitor being electrically connected to a second end of the inductor, and a second end of the sense capacitor being electrically connected to a second end of the sense resistor; and
wherein the sense voltage is derived between the sense capacitor and the sense resistor.

22. The set of DC to DC converters as claimed in claim 21, wherein the resistance Rs of the sense resistor, the capacitance Cs of the sense capacitor, and the conductance L and the DC resistance DCR of the inductor follow an equation as:
Rs×Cs=L/DCR

23. The set of DC to DC converters claimed in claim 21, further comprising:
an error amplifier arranged to provide the reference voltage, wherein an inverse input of the error amplifier is electrically connected to the second end of the inductor of each DC to DC converter, and a non-inverse input of the error amplifier is electrically connected to a second reference voltage.

24. The set of DC to DC converters as claimed in claim 18, wherein the inverter of each of the DC to DC converters comprises two switches electrically connected in series between the input voltage and the ground, the two switches are alternately switched and the output of the inverter is positioned between the two switches.

25. The set of DC to DC converters as claimed in claim 18, wherein the driver of each of the DC to DC converters is an SR latch or a flip-flop.
